(19) United States
(12) Patent Application Publication
(10) Pub. No.: US 2008/0049114 A1
(43) Pub. Date: Feb. 28, 2008

(54) APPARATUS AND METHOD FOR AUTOMATICALLY CONTROLLING ASPECT RATIO OF INPUT WINDOW OF CAMERA MODULE IN PORTABLE TERMINAL

(75) Inventor: Woo-Gun PARK, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/839,261

(22) Filed: Aug. 15, 2007

(30) Foreign Application Priority Data
Aug. 28, 2006 (KR) 2006-0081453

(51) Int. Cl. H04N 5/228

(52) U.S. Cl. 348/222.1; 348/E05.031

(57) ABSTRACT

Provided are an apparatus and a method for controlling an input window of a camera module in a portable terminal. The method includes determining if an aspect ratio of the input window is equal to an aspect ratio of an image output resolution; and adjusting the aspect ratio of the input window when the aspect ratio of the input window is not equal to the aspect ratio of the image output resolution.

### PRIORITY

This application claims priority under 35 U.S.C. § 119 to an application filed in the Korean Intellectual Property Office on Aug. 28, 2006 and allocated Serial No. 2006-81453, the contents of which are incorporated herein by reference.

### BACKGROUND OF THE INVENTION

1. Field of the Invention

The present invention relates generally to an image photographing apparatus and method.

2. Description of the Related Art

In recent years, portable terminals have become indispensable items for the modem consumer, and service providers and terminal manufacturers are competitively developing portable terminals and services in order to differentiate themselves from their competitors.

The portable terminals can provide a variety of additional functions and services such as a phone book function, a game function, a short message service, an e-mail service, a morning call function, an MPEG layer 3 (MP3) player function, a digital camera function, a wireless Internet service, and so on.

As the portable terminals with digital camera modules are becoming wide spread, users can easily photograph various images anytime and anywhere. In addition, as the number of pixels of the digital camera module increases, the portable terminals can also serve as a high-quality digital camera.

The portable terminals generally support a 4:3 aspect ratio image and an 11:9 aspect ratio image.

Video Graphics Array (VGA) with 640×480 pixels, Quarter VGA (QVGA) with 320×240 pixels, and Super VGA (SVGA) with 800×600 pixels work on the 4:3 aspect ratio image. Common Intermediate Format (CIF) with 352×288 pixels and Quarter CIF (QCIF) with 176×144 pixels work on the 11:9 aspect ratio image.

The digital camera module, however, receives image data through an input window having a fixed aspect ratio (e.g., 800×600 pixels). Accordingly, in the case where the digital camera module receives image data having a different output resolution (e.g., 176×144 pixels), an image that is not matched to the resolution is displayed.

For example, when the input window is fixed to a 4:3 aspect ratio with 800×600 pixels and an image of a basketball having a 11:9 aspect ratio is photographed through the input window, the image of the basketball is displayed as not the 4:3 aspect ratio image of FIG. 1A but as the 11:9 aspect ratio image of FIG. 1B

To solve this problem, the user manually requests to change the aspect ratio of the input window into the aspect ratio corresponding to the output image resolution. However, this method is very inconvenient to the users of the portable terminals.

Although the production of portable terminals supporting a scenic or portrait photographing mode is increasing, they have a drawback in that the user must manually readjust the aspect ratio of the input window.

Therefore, there is a need for an apparatus and method that can automatically adjust the aspect ratio of the input window.

### SUMMARY OF THE INVENTION

An object of the present invention is to substantially solve at least the above problems and/or disadvantages and to provide at least the advantages below. Accordingly, an object of the present invention is to provide an apparatus and method for automatically adjusting an aspect ratio of an input window depending on an image output resolution.

According to one aspect of the present invention, a method for automatically controlling an input window of a camera module in a portable terminal includes determining if an aspect ratio of the input window is equal to an aspect ratio of an image output resolution; and adjusting the aspect ratio of the input window when the aspect ratio of the input window is not equal to the aspect ratio of the image output resolution.

According to another aspect of the present invention, an apparatus for automatically controlling an input window of a camera module in a portable terminal includes a camera controller for adjusting an aspect ratio of the input Window when the aspect ratio of the input window is not equal to an aspect ratio of the image output resolution.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B illustrate images displayed when an input window is fixed to a 4:3 aspect ratio and a 11:9 aspect ratio;

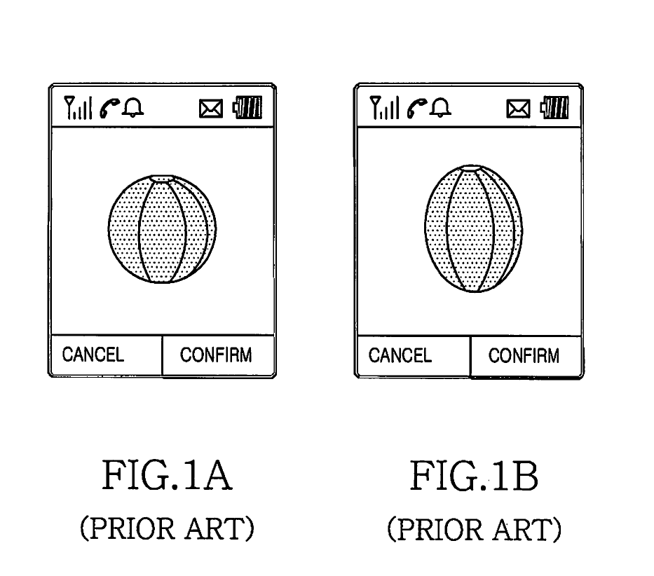

FIG. 2 is a block diagram of a camera module for automatically adjusting an aspect ratio of an input window according to the present invention;

FIG. 3 is a flowchart illustrating a method for automatically adjusting an aspect ratio of an input window depending on an image output resolution according to the present invention; and

FIGS. 4A through 4D illustrate images displayed on an input window, whose aspect ratio is automatically adjusted.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, an apparatus and method for automatically controlling an input window according to the present invention will be described in detail. The apparatus and method according to the present invention can automatically adjust an aspect ratio of the input window depending on an output image resolution.

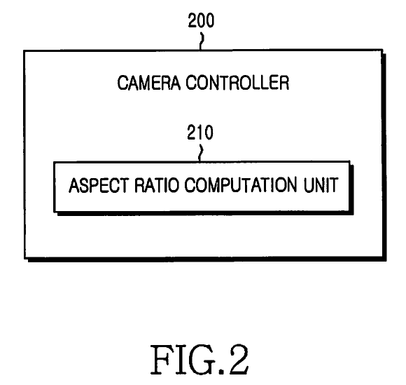

FIG. 2 is a block diagram of a camera module for automatically adjusting an aspect ratio of an input window depending on an image output resolution according to the present invention.

Referring to FIG. 2, the camera module includes a camera controller 200 with an aspect ratio computation unit 210.

The camera controller 200 controls an overall operation of the camera module to photograph an image. The camera controller 200 determines the image output resolution selected by a user and controls the aspect ratio computation unit 210 to compute an aspect ratio corresponding to the determined output image resolution. The camera controller 200 changes the aspect ratio of the input window into the computed aspect ratio.

For example, when the input window is previously set to a 4:3 aspect ratio with 800×600 pixels and the selected image output resolution is 176×144 pixels, the camera controller 200 automatically adjusts the 4:3 aspect ratio to the 11:9 aspect ratio with 726×594 pixels, computed by the aspect ratio computation unit 210.

Under control of the camera controller 200, the aspect ratio computation unit 210 confirms the selected image output resolution, computes the aspect ratio corresponding to the image output resolution, and provides the computed aspect ratio to the camera controller 200.

For example, when the selected image output resolution is 176×144 pixels, the aspect ratio computation unit 210 computes the aspect ratio (11:9) of the image output resolution and provides the computed aspect ratio to the camera controller 200.

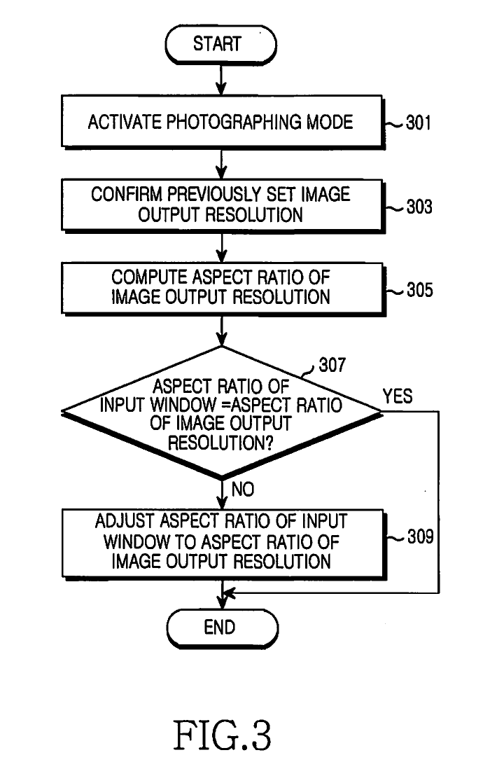

FIG. 3 is a flowchart illustrating a method for automatically adjusting an aspect ratio of an input window depending on an image output resolution according to the present invention.

Referring to FIG. 3, the camera controller 200 activates a photographing mode according to a user's request in step 301. In step 303, the camera controller 200 confirms a previously set output image resolution.

In step 305, the camera controller 200 controls the aspect ratio computation unit 210 to compute an aspect ratio of the image output resolution. For example, when the image output resolution is previously set to an 800×600 pixels (SVGA), the aspect ratio computation unit 210 determines that the image output resolution has a 4:3 aspect ratio.

In step 307, the camera controller 200 controls the aspect ratio computation unit 210 to compare the aspect ratio of the input window with the computed aspect ratio of the image output resolution.

When the aspect ratio of the input window is equal to the aspect ratio of the output image resolution, the camera controller 200 ends the process.

When the aspect ratio of the input window is not equal to the aspect ratio of the output image resolution, the camera controller 200 adjusts the aspect ratio of the input window to the aspect ratio of the output image resolution. Thereafter, the camera controller 200 ends the process.

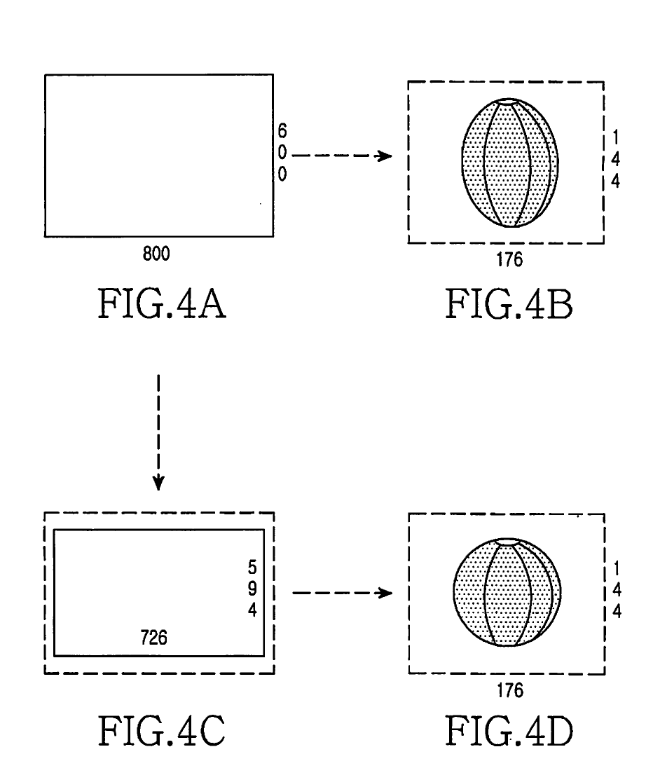

FIGS. 4A through 4D illustrate images displayed on the input window, whose aspect ratio is automatically adjusted.

FIG. 4A illustrates the input window having a 4:3 aspect ratio with 800×600 pixels. For example, when an image having an image output resolution of an 11:9 aspect ratio is photographed through the input window, the output image is distorted as illustrated in FIG. 4B.

FIG. 4C is illustrates the input window the aspect ratio, whose aspect ratio is automatically adjusted to the aspect ratio of the image output resolution. For example, when the selected image output resolution has the 11:9 aspect ratio with 176×144 pixels, the aspect ratio of the input window is automatically adjusted to the 11:9 aspect ratio. That is, the 4:3 aspect ratio of the input window with 800×600 pixels (indicated by a solid line) is adjusted to the 11:9 aspect ratio with 726×594 pixels (indicated by a dotted line).

FIG. 4D illustrates the image obtained through the input window, whose aspect ratio is automatically adjusted to the aspect ratio of the output image resolution. It can be seen from FIG. 4D that the image matched with the image output resolution is displayed by automatically adjusting the aspect ratio of the input window.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As described above, the aspect ratio of the input window can be automatically adjusted depending on the aspect ratio of the output image resolution, thereby improving the user's convenience.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for automatically controlling an input window of a camera module in a portable terminal, comprising the steps of:
determining if an aspect ratio of the input window is equal to an aspect ratio of an image output resolution; and
adjusting the aspect ratio of the input window when the aspect ratio of the input window is not equal to the aspect ratio of the image output resolution.

2. The method of claim 1, wherein the determining step comprises determining if the aspect ratio of the input window is equal to an aspect ratio of a previously set image output resolution.

3. The method of claim 1, wherein the adjusting step comprises adjusting the aspect ratio of the input window to the aspect ratio of the image output resolution.

4. An apparatus for automatically controlling an input window of a camera module in a portable terminal, comprising:
a camera controller for adjusting an aspect ratio of the input window when the aspect ratio of the input window is not equal to an aspect ratio of the image output resolution.

5. The apparatus of claim 4, wherein the camera controller confirms a previously set image output resolution, and includes an aspect ratio computation unit for computing the aspect ratio of the image output resolution.

6. The apparatus of claim 5, wherein the camera controller compares the computed aspect ratio of the image output resolution with the aspect ratio of the input window and determines if the aspect ratios are equal to each other.

7. The apparatus of claim 4, wherein the camera controller adjusts the aspect ratio of the input window to the aspect ratio of the image output resolution.

8. A method for automatically controlling an input window of a camera module in a portable terminal, comprising the step of:
adjusting an aspect ratio of the input window when the aspect ratio of the input window is not equal to the aspect ratio of an image output resolution.

9. The method of claim 8, further comprising, before the step of adjusting, a step of determining if an aspect ratio of the input window is equal to the aspect ratio of the image output resolution.

10. The method of claim 9, wherein the determining step comprises determining if the aspect ratio of the input window is equal to an aspect ratio of a previously set image output resolution.

11. The method of claim 8, wherein the adjusting step comprises adjusting the aspect ratio of the input window to the aspect ratio of the image output resolution.

12. A computer-readable recording medium having recorded thereon a program automatically controlling an input window of a camera module in a portable terminal, comprising:
a first segment, for determining if an aspect ratio of the input window is equal to an aspect ratio of an image output resolution; and
a second segment, for adjusting the aspect ratio of the input window when the aspect ratio of the input window is not equal to the aspect ratio of the image output resolution.
